(19) United States
(12) Patent Application Publication
(10) Pub. No.: US 2016/0156964 A1
(43) Pub. Date: Jun. 2, 2016

(54) INFORMATION TERMINAL, INFORMATION PROCESSING METHOD, AND CONTROL PROGRAM

(71) Applicant: Panasonic Intellectual Property Management Co., Ltd., Osaka (JP)

(72) Inventors: Mitsuhiro KAGEYAMA, Kanagawa (JP); Kouichi MATSUMURA, Osaka (JP)

(21) Appl. No.: 14/955,077

(22) Filed: Dec. 1, 2015

(30) Foreign Application Priority Data
Dec. 2, 2014 (JP) 2014-244506

(51) Int. Cl. H04N 21/4367; H04N 21/4627; H04N 21/442; H04L 29/08; H04N 21/41

(52) U.S. Cl. CPC H04N 21/4367; H04L 67/02; H04N 21/4113; H04N 21/4126; H04N 21/44204; H04N 21/4627

(57) ABSTRACT

An information terminal capable of communicating with a broadcast receiving device that receives TV broadcast includes a communicator, a storage unit for storing an application program that prescribes communication processing with the broadcast receiving device, and a controller. The controller performs mutual authentication with the broadcast receiving device to transmit first authentication information to the broadcast receiving device. Furthermore, the controller verifies validity of the application program stored in the storage unit. When the verified application program is valid, the controller performs control to transmit second authentication information verifiable by using the first authentication information in communication with the broadcast receiving device according to the application program. This inhibits the information terminal capable of communicating with the broadcast receiving device from executing an invalid application program that causes a problem such as invalid acquisition of data in the broadcast receiving device.

### BACKGROUND

1. Technical Field

The present disclosure relates to an information terminal that communicates with a television broadcast receiving device that supports broadcast and communication cooperation.

2. Description of the Related Art

Unexamined Japanese Patent Publication No. H09-331368 discloses a technique to allow an apparatus equipped with a plurality of types of protocols to select and apply each of the protocols to communicate with various apparatuses.

Unexamined Japanese Patent Publication No. 2005-293504 discloses a technique to verify validity of an application program by checking contents of a memory before start-up of the application program.

### SUMMARY

The present disclosure provides an information terminal capable of communicating with a broadcast receiving device that receives television broadcast (hereinafter referred to as “TV broadcast”).

The information terminal according to the present disclosure is an information terminal capable of communicating with the broadcast receiving device that receives television broadcast, the information terminal including: a communicator; a storage unit for storing an application program that prescribes communication processing with the broadcast receiving device; and a controller configured to perform mutual authentication with the broadcast receiving device to transmit first authentication information to the broadcast receiving device, to further verify validity of the application program stored in the storage unit, and to perform control, when the verified application program is valid, to transmit, to the broadcast receiving device, second authentication information verifiable by using the first authentication information in communication with the broadcast receiving device according to the application program.

An information processing method according to the present disclosure is an information processing method used by an information terminal capable of communicating with a broadcast receiving device that receives television broadcast, the information processing method including: a transmission step of performing mutual authentication with the broadcast receiving device to transmit first authentication information to the broadcast receiving device; a verification step of verifying validity of an application program stored in the information terminal; and a control step of performing control, when the application program verified in the verification step is valid, to transmit second authentication information verifiable by using the first authentication information to the broadcast receiving device in communication with the broadcast receiving device to which the first authentication information is transmitted in the transmission step, according to the application program.

A control program according to the present disclosure is a control program for performing predetermined information processing through execution by a processor of an information terminal capable of communicating with a broadcast receiving device that receives television broadcast, the predetermined information processing including: a transmission step of performing mutual authentication with the broadcast receiving device to transmit first authentication information to the broadcast receiving device; a verification step of verifying validity of an application program stored in the information terminal; and a control step of performing control, when the application program verified in the verification step is valid, to transmit second authentication information verifiable by using the first authentication information to the broadcast receiving device in communication with the broadcast receiving device to which the first authentication information is transmitted in the transmission step, according to the application program.

The information terminal, information processing method, etc. according to the present disclosure may inhibit the information terminal capable of communicating with the broadcast receiving device from causing a problem such as invalid acquisition of data, when the information terminal executes an invalid application program.

### BRIEF DESCRIPTION OF DRAWINGS

FIG. 1 is a schematic configuration diagram of a broadcast and communication cooperation system according to a first exemplary embodiment;

FIG. 2 is a block diagram illustrating a functional configuration of an information terminal and a broadcast receiving device;

FIG. 3 is a block diagram illustrating a configuration of software that runs on the information terminal;

FIG. 4 is a diagram illustrating a configuration and an example of contents of communication method information;

FIG. 5 is a diagram illustrating a configuration and an example of contents of connection management information;

FIG. 6 is a diagram illustrating a configuration and an example of contents of usage information;

FIG. 7 is a flow chart illustrating an operation of the broadcast receiving device;

FIG. 8 is a flow chart illustrating an operation of the information terminal;

FIG. 9 is a diagram illustrating contents of a response from the broadcast receiving device to getURL from the information terminal;

FIG. 10 is a conceptual diagram about a method for confirming validity of a web site in the information terminal;

FIG. 11 is a diagram illustrating an operation sequence related to exchange of data, etc.;

FIG. 12 is a diagram illustrating an operation sequence related to exchange of data, etc.;

FIG. 13 is a communication sequence diagram illustrating communication in the broadcast receiving device, the information terminal, etc.;

FIG. 14 is a communication sequence diagram illustrating communication in the broadcast receiving device, the information terminal, etc.; and

FIG. 15 is a diagram illustrating an operation sequence related to exchange of data, etc. according to other exemplary embodiments.

### DETAILED DESCRIPTION

In order to inhibit a problem, such as invalid acquisition of data, from occurring when an invalid application program is executed on an information terminal, the information terminal according to the present disclosure is an information terminal capable of communicating with a broadcast receiving device that receives television broadcast, the information terminal including: a communicator; a storage unit for storing an application program that prescribes communication processing with the broadcast receiving device; and a controller configured to perform mutual authentication with the broadcast receiving device to transmit first authentication information to the broadcast receiving device, to further verify validity of the application program stored in the storage unit, and to perform control, when the verified application program is valid, to transmit, to the broadcast receiving device, second authentication information verifiable by using the first authentication information in communication with the broadcast receiving device according to the application program. The validity of the application program may be verified through authentication of the application program, or through confirmation of validity of a web site which is a source of the application program. The first authentication information and the second authentication information may be a set having a certain relationship so that the validity of the second authentication information may be verified by using the first authentication information. The first authentication information and the second authentication information may have an identical value, or may not have an identical value.

Accordingly, since the second authentication information is transmitted when the application program whose validity has been verified communicates with the broadcast receiving device, the broadcast receiving device is capable of determining whether the communication is made with a valid partner by verifying the second authentication information based on the first authentication information. Therefore, the broadcast receiving device may inhibit occurrence of a problem, such as invalid acquisition of data, by communicating only with a valid partner. Thus, the information terminal will be useful for inhibition of occurrence of a problem such as invalid acquisition of data in the broadcast receiving device.

For example, the second authentication information may be identical to the first authentication information.

This reduces a burden of generation, management, and impartation of the authentication information in the information terminal, for example, compared with a case where the first authentication information differs from the second authentication information. Also in the broadcast receiving device, this reduces a burden of verification of the authentication information received from the information terminal.

Meanwhile, for example, the controller may generate the first authentication information having a value independent of a value of the already generated first authentication information with each mutual authentication performed with the broadcast receiving device.

This reduces occurrence of a problem caused by leakage of the first authentication information, for example, compared with a case where the first authentication information is permanently used. This is useful, for example, when the first authentication information and the second authentication information are identical to each other.

When the verified application program is valid, the controller may impart the second authentication information to the application program so that the second authentication information may be used in the communication processing according to the application program.

This allows the valid application program to exchange data with the broadcast receiving device by using the imparted second authentication information.

When the verified application program is valid, the controller may perform control to transmit data to which the second authentication information is appended to the broadcast receiving device, every time transmission of the data to the broadcast receiving device is specified in the communication processing according to the application program.

This eliminates a need for the valid application program to perform particular processing regarding transmission of the authentication information because the second authentication information is appended when the valid application program transmits the data to the broadcast receiving device.

The controller may receive specified information that indicates the application program from the mutually authenticated broadcast receiving device, and may perform the verification of validity of the application program indicated by the specified information.

This causes the information terminal to execute the application program related to a broadcast program the broadcast receiving device is receiving. This leads to provision of information, service, etc. regarding the broadcast program to a viewer of the broadcast program through the information terminal. This also allows processing to be performed according to the application program, including exchange of data between the information terminal and the broadcast receiving device.

The controller may receive specified information that indicates a web site from the mutually authenticated broadcast receiving device, and may perform the verification of validity of the application program by confirming that the web site indicated by the specified information is valid.

This allows the information terminal to execute the application program downloaded from the web site that provides web content related to the broadcast program the broadcast receiving device is receiving. This leads to provision of information, service, etc. regarding the broadcast program to the viewer of the broadcast program through the information terminal. This also allows processing to be performed according to the application program, including exchange of data between the information terminal and the broadcast receiving device.

The controller may perform the mutual authentication with the broadcast receiving device that has become capable of communication through the communicator by selectively using a plurality of communication methods.

This allows the information terminal to support various types of broadcast receiving devices capable of communicating with the information terminal by a plurality of communication methods different from one another.

When the verified application program is valid, the controller may record a frequency of use of the broadcast receiving device for each manufacturer in association with manufacturer identification information on the broadcast receiving device used when communication with the broadcast receiving device becomes possible, and may perform control to transmit usage information that indicates the recorded frequency of use for each manufacturer to a predetermined external device.

This allows the predetermined external device such as a server to total the frequency of use of the broadcast receiving device for each manufacturer and to perform processing such as money calculation according to the frequency of use of the broadcast receiving device for each manufacturer, because the frequency of use of the broadcast receiving device for each manufacturer is transmitted to the external device.

An information processing method according to the present disclosure is an information processing method used by an information terminal capable of communicating with a broadcast receiving device that receives television broadcast, the information processing method including: a transmission step of performing mutual authentication with the broadcast receiving device to transmit first authentication information to the broadcast receiving device; a verification step of verifying validity of an application program stored in the information terminal; and a control step of performing control, when the application program verified in the verification step is valid, to transmit second authentication information verifiable by using the first authentication information to the broadcast receiving device in communication with the broadcast receiving device to which the first authentication information is transmitted in the transmission step, according to the application program.

This allows the broadcast receiving device to determine whether the communication is made with a valid partner by verifying the second authentication information based on the first authentication information, because the second authentication information is transmitted when the application program whose validity has been verified communicates with the broadcast receiving device.

A control program according to the present disclosure is a control program for performing predetermined information processing through execution by a processor of an information terminal capable of communicating with a broadcast receiving device that receives television broadcast, the predetermined information processing including: a transmission step of performing mutual authentication with the broadcast receiving device to transmit first authentication information to the broadcast receiving device; a verification step of verifying validity of an application program stored in the information terminal; and a control step of performing control, when the application program verified in the verification step is valid, to transmit second authentication information verifiable by using the first authentication information to the broadcast receiving device in communication with the broadcast receiving device to which the first authentication information is transmitted in the transmission step, according to the application program.

This causes the information terminal including a memory and processor, in which the control program is installed, that is, a computer to transmit the second authentication information when the application program whose validity has been verified communicates with the broadcast receiving device. Therefore, the broadcast receiving device becomes capable of determining whether the communication is made with a valid partner, by verifying the second authentication information based on the first authentication information. Thus, the information terminal that executes the control program contributes to inhibition of occurrence of a problem such as invalid acquisition of data in the broadcast receiving device.

These comprehensive or specific aspects may include one or more combinations of a device, a system, a method, an integrated circuit, a computer program, a computer-readable storage medium, and the like.

Exemplary embodiments will be described in detail below with reference to the drawings as needed. However, a description more detailed than necessary may be omitted. For example, a detailed description of an already well-known item and a repeated description of substantially identical components may be omitted. This is intended to avoid the following description from becoming unnecessarily redundant and to make the description easier for a person skilled in the art to understand.

It is to be noted that the inventor provides the accompanying drawings and the following description in order for a person skilled in the art to fully understand the present disclosure, and does not intend to limit the subject described in the appended claims. That is, a numerical value, shape, material, component, arrangement and connection form of the component, a step (process) and a sequence of the step, and the like indicated in the following description using specific examples are one example, and do not limit the subject described in the claims. Among the components in the following exemplary embodiments, components not described in an independent claim are components that may be arbitrarily added. Each diagram is a schematic view and is not necessarily illustrated strictly.

### First Exemplary Embodiment

Broadcast and communication cooperation system 10 according to a first exemplary embodiment will be described below with reference to the drawings.

### [1-1. Configuration]

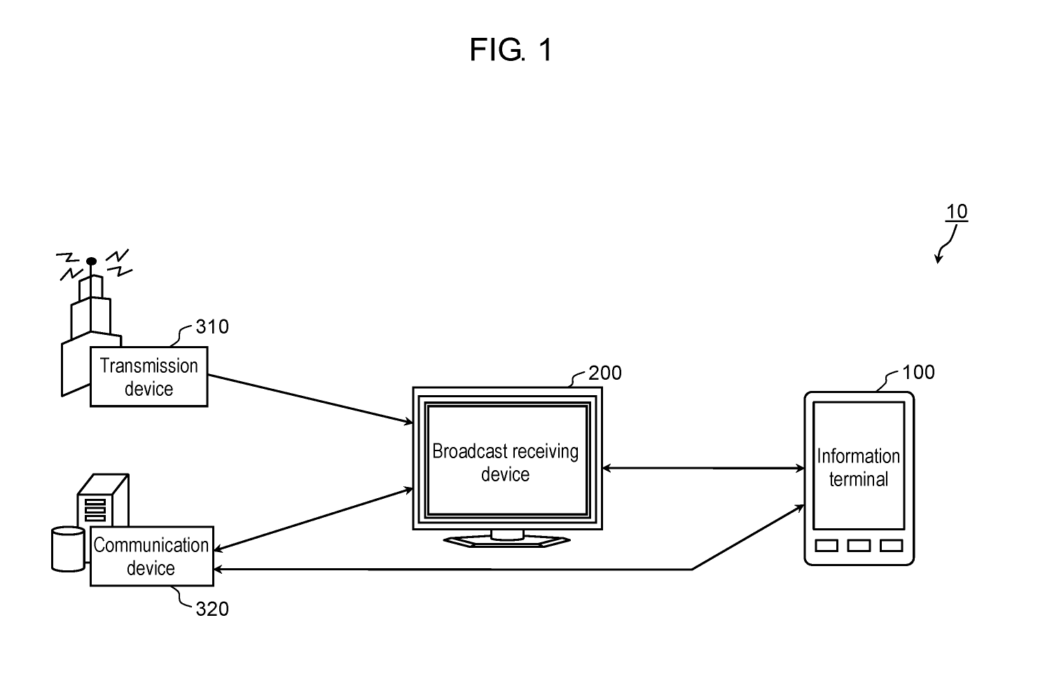

FIG. 1 is a schematic configuration diagram of broadcast and communication cooperation system 10 according to the first exemplary embodiment.

Broadcast and communication cooperation system 10 is a system for providing a viewer with television service by cooperation between broadcast and communication. As illustrated in FIG. 1, broadcast and communication cooperation system 10 includes transmission device 310 and communication device 320 that provide television service by broadcast and communication, and broadcast receiving device 200 and information terminal 100 which are used by a user (viewer) directly. Hereinafter, each of these devices will be described.

Transmission device 310 is installed in a broadcast station, for example. Transmission device 310 transmits TV broadcast to broadcast receiving device 200 through a communication path such as broadcast waves or cables.

Communication device 320 is installed in a broadcast station or other information management facilities, for example. Communication device 320 is connected to a wide area network (WAN), such as the Internet, and has a function such as a web server function to distribute web content described in a language such as HTML (Hyper Text Markup Language) 5 through the network to broadcast receiving device 200.

Broadcast receiving device 200 is, for example, a device that is typically installed in a facility such as a residence, and is used by the user (viewer) such as a television (television receiver), a set top box (STB), and a recording and playback device. Broadcast receiving device 200 receives TV broadcast transmitted from transmission device 310. Broadcast receiving device 200 includes a broadcast receiving circuit, a memory, a storage medium such as a hard disk device, a processor, a communication interface, a display, and a remote control, for example. Broadcast programs that constitute TV broadcast include broadcast programs that support broadcast and communication cooperation service, and broadcast programs that do not support broadcast and communication cooperation service.

Broadcast receiving device 200 has a web browser function for acquiring and displaying web content from communication device 320 when receiving a broadcast program that supports broadcast and communication cooperation service from transmission device 310.

In addition, broadcast receiving device 200 has a function of wireless or wired communication with information terminal 100 via a local area network (LAN). Although FIG. 1 illustrates one broadcast receiving device 200 for convenience, broadcast and communication cooperation system 10 may include various types of broadcast receiving devices 200 respectively manufactured by a plurality of manufacturers. Any type of broadcast receiving device 200 may use certain identical communication protocol (for example, Internet protocol of a network layer, etc.) in layers from an application layer to a network layer when communicating with information terminal 100. However, in broadcast receiving devices 200 of types different from each other, some communication method to be used for communication with information terminal 100 (for example, a data link layer) may differ.

Information terminal 100 is a computer that has communication functions and is held by the user, such as a smart phone, tablet, PC, and game machine, for example. Information terminal 100 includes a memory, a storage medium such as a hard disk device, a processor, a communication interface, an input-output unit such as a touch panel including a display, and the like. Although FIG. 1 illustrates only one information terminal 100 for convenience, a plurality of information terminals 100 may exist. The above-described communication interface is a communication circuit, etc. for exchanging data with other devices. The above-described memory is a device such as an ROM and an RAM, and may include a nonvolatile memory. Such a memory previously stores data such as a control program for implementing processing of each functional unit to be described later, and setting values to be used by the control program. In addition, the memory is also used for temporarily storing values to be used for execution of the control program by the processor.

An example of operation of broadcast and communication cooperation system 10 is as follows, for example. Broadcast receiving device 200 receives a broadcast program that supports broadcast and communication cooperation from transmission device 310, and displays the broadcast program on a display. Moreover, broadcast receiving device 200 accesses communication device 320, acquires web content, and displays the web content on the display. The user who is viewing the broadcast program with broadcast receiving device 200 manipulates information terminal 100 to start a predetermined program for performing cooperative operation with broadcast receiving device 200 (referred to as “a relay program”).

This causes information terminal 100 to communicate with broadcast receiving device 200, to execute a specific application program corresponding to, for example, the broadcast program (referred to as “external application”) in response to an instruction from broadcast receiving device 200, or to display specific web content with a web browser. The web content may include an application program (referred to as “browser application”) described in a script, running on the web browser.

Thus, exchange of data between information terminal 100 and broadcast receiving device 200 enables the user (viewer) to receive various types of information or services related to the broadcast program.

A functional configuration of information terminal 100 and broadcast receiving device 200 in broadcast and communication cooperation system 10 described above will be described in detail below.

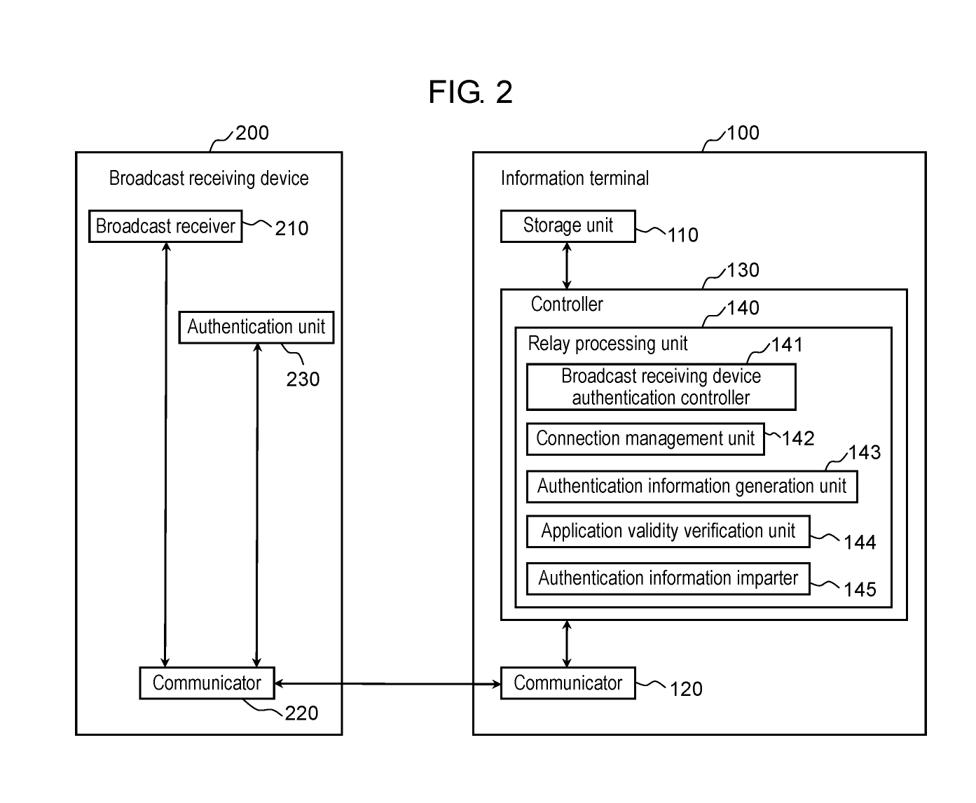

FIG. 2 is a functional block diagram illustrating each functional configuration of information terminal 100 and broadcast receiving device 200 in broadcast and communication cooperation system 10.

Broadcast receiving device 200 includes broadcast receiver 210, communicator 220, and authentication unit 230 as major functional components. Broadcast receiver 210 is implemented by components such as a broadcast receiving circuit, a memory, and a processor, and achieves a function to receive TV broadcast. Communicator 220 is implemented by components such as a communication interface, a memory, and a processor, and has a function to communicate with communication device 320 and information terminal 100. Authentication unit 230 has a function to perform mutual authentication when communicator 220 communicates with information terminal 100, and to retain authentication information received from information terminal 100, and uses the authentication information to verify whether data to be received later from information terminal 100 is data from a valid source. Authentication unit 230 is implemented by components such as a memory and a processor.

Information terminal 100 includes storage unit 110, communicator 120, and controller 130, as illustrated in FIG. 2 in terms of functions. Each functional unit (that is, functional component) of information terminal 100 will be described below.

Storage unit 110 is implemented in some region of a storage medium such as a memory. Storage unit 110 has a function to store data of web content, including a browser application downloaded from an external device such as communication device 320, external applications, and communication method information, connection management information, and usage information to be described later.

Communicator 120 achieves a function to communicate with broadcast receiving device 200 via LAN in response to control by controller 130. Communicator 120 further has a function to communicate with external devices such as communication device 320 and other external servers via WAN. Communicator 120 is implemented by a communication interface and a processor that executes a control program stored in the memory.

Controller 130 has a function to control each unit of information terminal 100, and to control execution of applications such as the external applications, or the web browser and the browser application. Controller 130 is implemented by a device such as a processor that executes the control program stored in the memory, and this control program includes programs such as an operating system and the above-described relay program, for example. While the relay program may be an application program or a part of the operating system (OS), the following description assumes that the relay program is a program that runs on the OS. Controller 130 includes relay processing unit 140 as a functional portion implemented by the processor that executes this relay program.

Relay processing unit 140 performs processing for enabling cooperation between the external application and browser application, and broadcast receiving device 200, and performs processing for counting manufacturer ID (manufacturer identification information) of broadcast receiving device 200 with which the external application and browser application cooperate for each manufacturer ID. In addition, relay processing unit 140 performs processing for transmitting a result of the count (that is, transmitting usage information) to a predetermined server (which may be communication device 320 or another device) disposed for totaling and processing the result of the count (for example, money calculation processing such as billing according to usage results for each manufacturer).

As functional components for enabling cooperation between the external application, etc. and broadcast receiving device 200, relay processing unit 140 mainly includes broadcast receiving device authentication controller 141, connection management unit 142, authentication information generation unit 143, application validity verification unit 144, and authentication information imparter 145. Functions of these functional components are implemented by the processor executing the relay program.

Broadcast receiving device authentication controller 141 has a function to control communicator 120 to communicate with broadcast receiving device 200 with reference to the communication method information stored in storage unit 110, and to perform mutual authentication between broadcast receiving device 200 and information terminal 100.

Connection management unit 142 has a function to retain and update the connection management information in storage unit 110.

Authentication information generation unit 143 has a function to generate the authentication information to be used for authentication when information terminal 100 communicates with broadcast receiving device 200 through execution of the external application or the browser application. Authentication information generation unit 143 generates the authentication information, for example, when communication starts with broadcast receiving device 200, that is, when performing the mutual authentication. The authentication information is information that represents a character string (character code string) as an example. For example, the authentication information is generated randomly with each generation, that is, generated so as to have a value independent of authentication information generated in the past.

Application validity verification unit 144 has a function to verify validity of the external application through authentication of the external application. Application validity verification unit 144 also has a function to indirectly verify validity of the browser application included in the web content downloaded from the web site, by confirming whether the web site is valid.

Authentication information imparter 145 has a function to transmit the authentication information generated by authentication information generation unit 143 to broadcast receiving device 200. Furthermore, authentication information imparter 145 has a function to impart, that is, convey the authentication information to the external application or browser application so that the authentication information may be used for communication with broadcast receiving device 200, made by execution of the external application or browser application that has been verified to be valid.

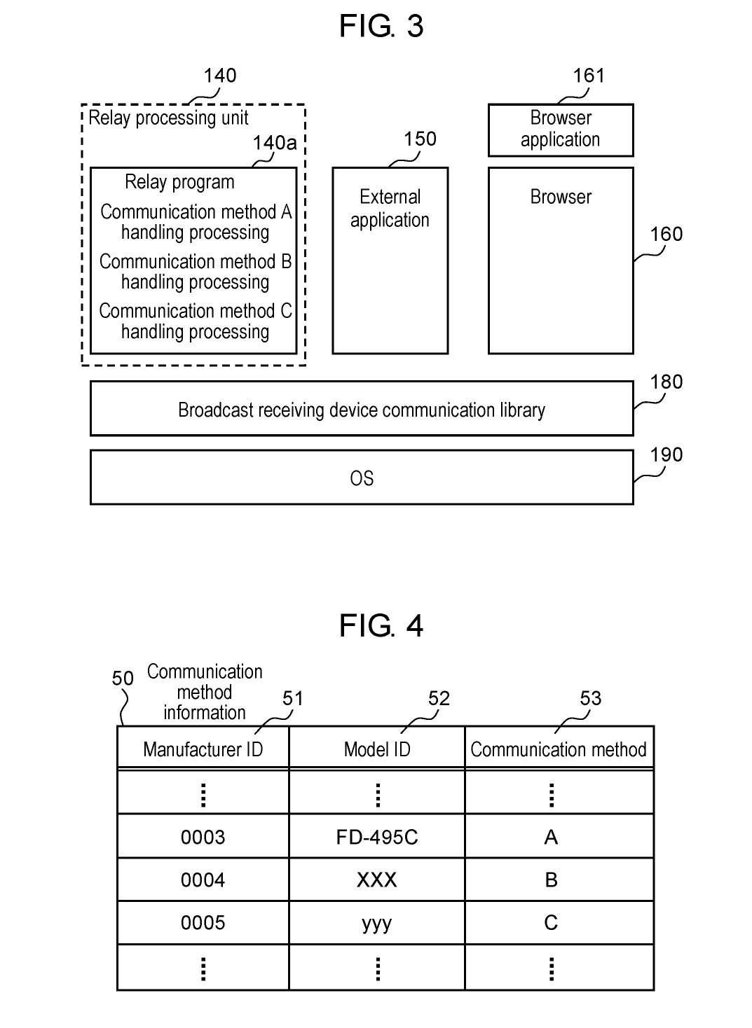

FIG. 3 is a block diagram illustrating a configuration of software that runs on information terminal 100 (that is, programs stored in the memory and to be executed by the processor). The software illustrated in a lower portion of FIG. 3 is software that constitutes execution environments of the programs illustrated in an upper portion of the diagram.

As illustrated in FIG. 3, in information terminal 100, relay program 140a, external application 150, and browser 160 (web browser) run on OS 190, and browser application 161 runs on browser 160. Broadcast receiving device communication library 180 provides an application program interface (API) to be used for communication with broadcast receiving device 200, and external application 150 and browser application 161 use this API. Relay program 140a is a program for functioning as above-described relay processing unit 140 through execution by the processor. Relay program 140a includes an instruction string that implements an algorithm etc. that enables communication with various types of broadcast receiving device 200 that differ in the communication method based on the communication method information stored in storage unit 110.

The above-described communication method information, connection management information, and usage information which are stored in storage unit 110 will be described below with reference to FIG. 4 to FIG. 6.

FIG. 4 is a diagram illustrating a configuration and an example of contents of communication method information 50. Communication method information 50 is information to be used for communication with various types of broadcast receiving devices 200 manufactured by respective manufacturers. As illustrated in FIG. 4, communication method information 50 is information that associates manufacturer ID 51 and model ID 52 with communication method 53 for each type of broadcast receiving device 200.

Manufacturer ID 51 is identification information on a manufacturer that manufactures broadcast receiving device 200. Model ID 52 is identification information for distinguishing model numbers of various types of broadcast receiving devices 200 manufactured by each manufacturer, and for example, is a name of the model, etc. Communication method 53 is information that represents the communication method of a data link layer, etc. that may be used for communication between information terminal 100 and broadcast receiving device 200 represented by corresponding manufacturer ID 51 and model ID 52. For convenience, FIG. 4 illustrates an example of contents in which communication method 53 includes only various methods different from one another, such as A, B, and C, but communication method 53 may include information that specifies an algorithm, etc. related to a communication procedure in each method, for example. Based on communication method information 50, broadcast receiving device authentication controller 141 controls communicator 120 to perform communication with broadcast receiving device 200.

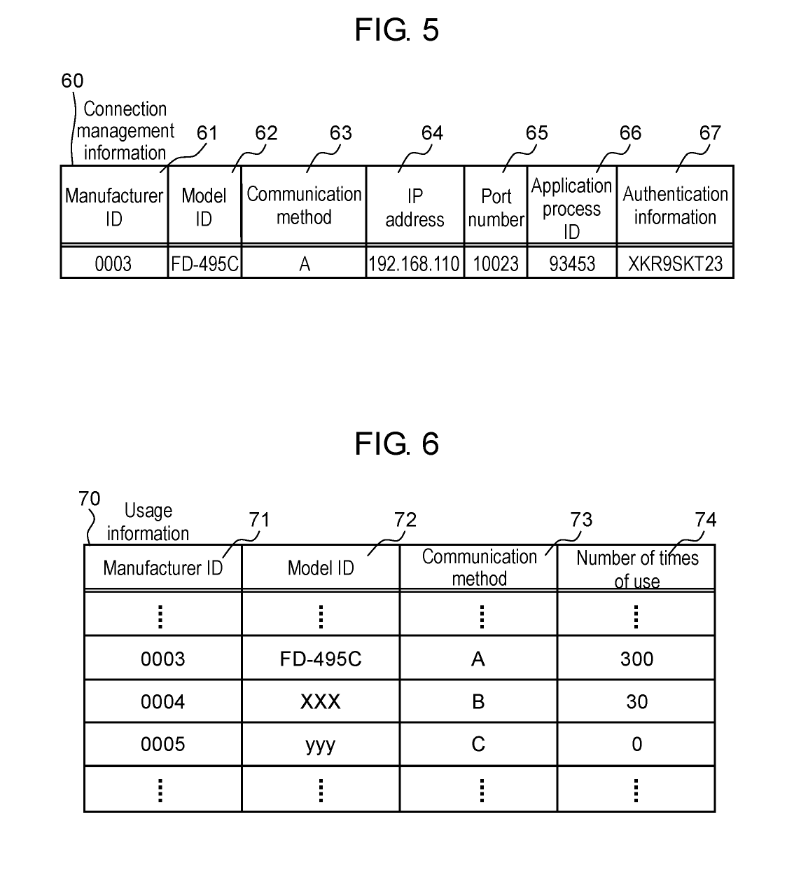

FIG. 5 is a diagram illustrating a configuration and an example of contents of connection management information 60. Connection management information 60 is information to be stored and retained in storage unit 110 by connection management unit 142 to allow information terminal 100 to connect to broadcast receiving device 200. Connection management information 60 is also information to be referred to by relay processing unit 140 from storage unit 110 as necessary. As illustrated in FIG. 5, connection management information 60 includes information on connected broadcast receiving device 200 such as manufacturer ID 61, model ID 62, communication method 63, IP address 64, and port number 65, information on the external application such as application process ID 66, and authentication information 67. Manufacturer ID 61, model ID 62, and communication method 63 are equal to manufacturer ID 51, model ID 52, and communication method 53 which are described above. IP address 64 is an IP address of broadcast receiving device 200 on LAN. Port number 65 is a number of a communication port corresponding to a socket of service in broadcast receiving device 200 for communication with information terminal 100. Application process ID 66 is, when relay processing unit 140, etc. starts an external application in response to specification from broadcast receiving device 200, identification information on a process corresponding to the external application. Authentication information 67 is authentication information generated by authentication information generation unit 143.

FIG. 6 is a diagram illustrating a configuration and an example of contents of usage information 70. Usage information 70 represents a frequency of use of various communication methods used by the external application and browser application to cooperate with broadcast receiving device 200, and is used for transmission to a predetermined server. As illustrated in FIG. 6, usage information 70 is information that associates manufacturer ID 71, model ID 72, and communication method 73 with number of times of use 74 for each communication method, that is, for each type of broadcast receiving device 200. Manufacturer ID 71, model ID 72, and communication method 73 are equal to manufacturer ID 51, model ID 52, and communication method 53 which are described above. Number of times of use 74 is numerical information that represents the number of times of use of manufacturer ID 71 of broadcast receiving device 200 used for communication, and is incremented every time manufacturer ID 71 is used. The example of contents of FIG. 6 represents a state where manufacturer ID 0003 is used 300 times for communication, and where communication method B is used 30 times.

### [1-2. Operation]

The following description of an operation of broadcast and communication cooperation system 10 having the above-mentioned configuration particularly focuses on broadcast receiving device 200 and information terminal 100.

### [1-2-1. Operation of the Broadcast Receiving Device]

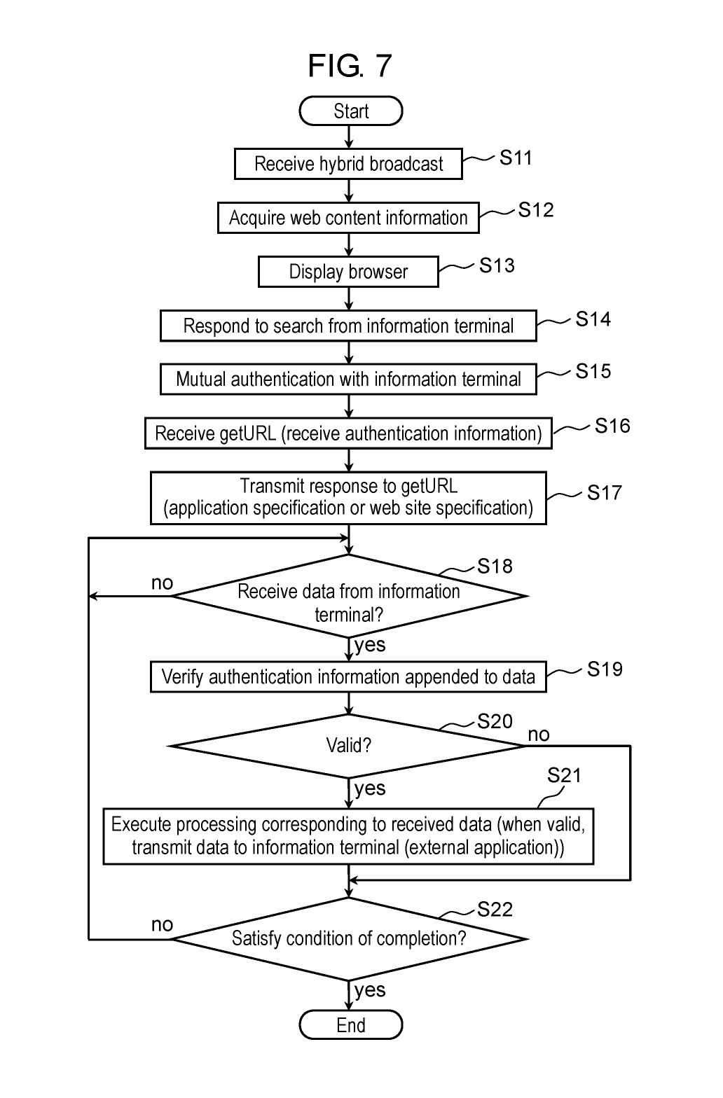

FIG. 7 is a flow chart illustrating the operation of broadcast receiving device 200.

Broadcast receiver 210 of broadcast receiving device 200 receives a broadcast program that supports broadcast and communication cooperation (hybrid broadcast) in TV broadcast transmitted from transmission device 310 (step S11). Broadcast receiving device 200 displays an image based on data of the received broadcast program on a display, etc., and outputs a sound from a speaker, etc. For example, broadcast receiver 210 of broadcast receiving device 200 determines that the broadcast program supports broadcast and communication cooperation with reference to information in data for data broadcast corresponding to the broadcast program, and acquires web content information specified in TV broadcast (step S12). The web content information represents, for example, information for access to a web page group described in HTML5 for providing information, service, etc. related to the broadcast program. The web content information may contain information for access to web content to be displayed on information terminal 100 or information indicating an external application to be executed in information terminal 100. Communicator 220 of broadcast receiving device 200 acquires the web content from communication device 320, and displays an image related to the web content with a web browser on a display (step S13). Broadcast receiving device 200 receives TV broadcast data sequentially, outputs images and sounds of the broadcast program from a display, a speaker, etc., and displays the image related to the web content. The following description pays particular attention to an operation for cooperation with information terminal 100. When the user who is viewing the broadcast program performs a manipulation related to an instruction to execute a relay program of information terminal 100, information terminal 100 searches for broadcast receiving device 200 capable of communication.

In response to the search from information terminal 100, broadcast receiving device 200 transmits a response (step S14). For example, information terminal 100 makes a search with an UPnP (Universal Plug and Play) M-search message. In accordance with UPnP, the M-search message is multicasted by information terminal 100 based on an instruction of “M-SEARCH*HTTP/1.1MX:3 HOST:239.255.255.250:1900 MAN:”ssdp:discover” ST:upnp: routdevice”, for example. The response to be transmitted by broadcast receiving device 200 represents the manufacturer ID, the model ID, the communication method, the local IP address, and the port number of a predetermined communication port of broadcast receiving device 200. This response is, for example, “HTTP/1.1 200 OK CACHE-CONTROL: max-age=120 Location: http://192.168.1.10:10023/upnp/003/FD-495 C/rootdevice.xml . . . ”.

Next, authentication unit 230 of broadcast receiving device 200 controls communicator 220 to perform the mutual authentication with information terminal 100 in accordance with a predetermined mutual authentication procedure (step S15). The mutual authentication is performed, for example, by an authentication procedure based on PKI (Public Key Infrastructure) (for example, a procedure in accordance with a handshaking protocol). When the mutual authentication succeeds, communicator 220 of broadcast receiving device 200 opens a predetermined communication port by a web socket service for communication with information terminal 100.

On receipt of a getURL message to which authentication information is appended from information terminal 100 (step S16), communicator 220 transmits, to information terminal 100, specification information that indicates an external application (referred to as “application specification”) or specified information that indicates web content (referred to as “web site specification”) based on web content information, as a response to the getURL message (step S17). The getURL message is a previously determined communication message for communication between broadcast receiving device 200 and information terminal 100, and is a message for requesting for specification of a resource to be used. In step S16, authentication unit 230 retains the authentication information received from information terminal 100 by communicator 220.

When communicator 220 of broadcast receiving device 200 receives data from information terminal 100 (step S18), authentication unit 230 verifies whether the data is valid data (that is, data from a valid source) (step S19). This verification is performed through confirmation whether information identical to the authentication information retained in step S16 is contained in the data received from information terminal 100 in step S18. When the identical information is contained, the data is determined to be valid data. Only when the data is valid (step S20), broadcast receiving device 200 executes processing corresponding to the received data (step S21). Examples of the processing corresponding to the received data include processing for transmitting to information terminal 100 personal information and other information that are previously input by the user into broadcast receiving device 200 to convey the information to the external application or the browser application. When the verification in step S19 results in that the data received from information terminal 100 in step S18 is not valid data, broadcast receiving device 200 abandons the data (that is, neglects the data), and inhibits execution of processing corresponding to the data (for example, information transmission). That is, on receipt of data to which the authentication information is not imparted, transmitted from information terminal 100 based on an invalid external application, etc., broadcast receiving device 200 does not respond.

In response to a manipulation of the user for stopping viewing, when a previously determined condition of completion is satisfied, such as when the broadcast program is finished (step S22), broadcast receiving device 200 closes the communication port, and stops the operation related to receipt of TV broadcast. Until the condition of completion is satisfied, broadcast receiving device 200 waits for receipt of data from information terminal 100 (steps S22, S18).

### [1-2-2. Operation of the Information Terminal]

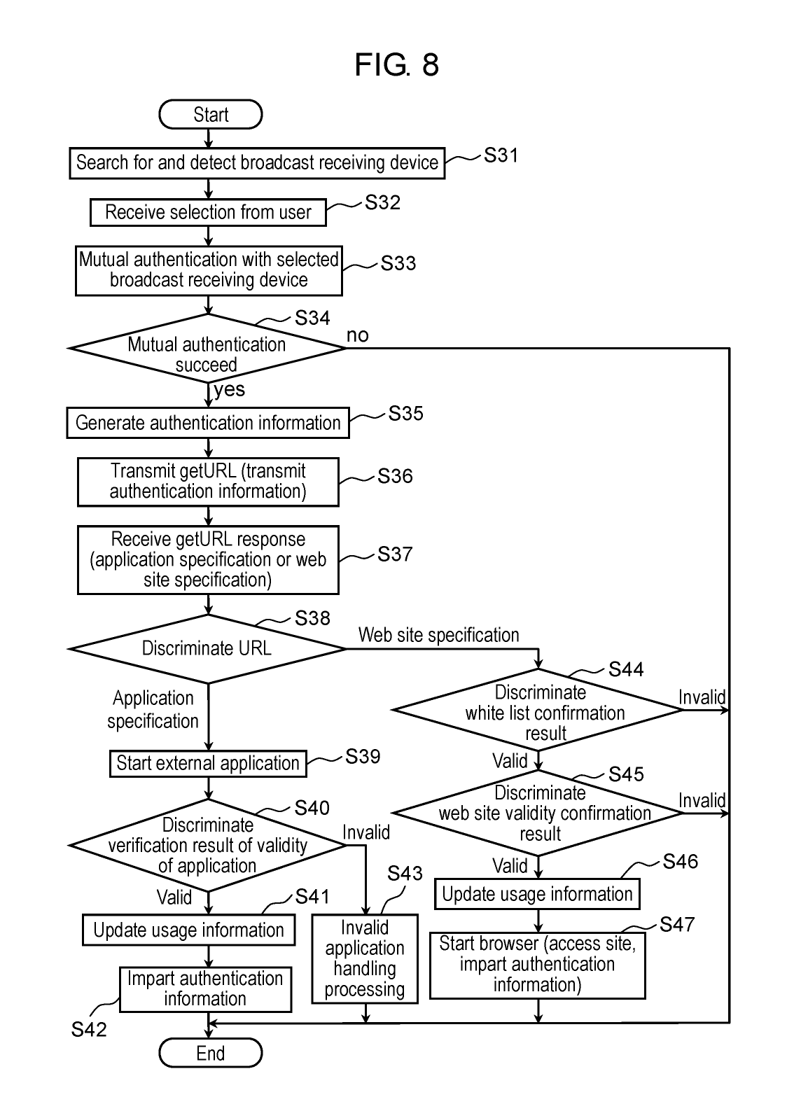

FIG. 8 is a flow chart illustrating an operation of information terminal 100. This flow chart illustrates the major operation regarding cooperation with broadcast receiving device 200. The operation of information terminal 100 will be described below with reference to FIG. 8. The following description assumes that information terminal 100 has already acquired the external application downloaded from communication device 320 or other servers.

When the user who is viewing the broadcast program with broadcast receiving device 200 performs a manipulation related to an instruction to execute the relay program of information terminal 100, etc., the processor that functions as controller 130 of information terminal 100 causes relay processing unit 140 to function by executing the relay program.

Relay processing unit 140 of controller 130 searches for broadcast receiving device 200 and detects a response (step S31). This corresponds to above-described processing in step S14 of broadcast receiving device 200. Connection management unit 142 of relay processing unit 140 stores in storage unit 110 the manufacturer ID, the model ID, the communication method, the local IP address, and the port number which are contained in the response received from broadcast receiving device 200, as connection management information 60. When a plurality of broadcast receiving devices 200 may communicate with information terminal 100 via LAN, the plurality of broadcast receiving devices 200 returns responses to the search.

Relay processing unit 140 displays on the display of information terminal 100, for example, information about one or more broadcast receiving devices 200 (for example, the model ID) that return the response to the search as options, and receives selection from the user (step S32). Broadcast receiving device authentication controller 141 of relay processing unit 140 then communicates with broadcast receiving device 200 selected by the user, and performs mutual authentication (step S33). When the mutual authentication fails, information terminal 100 does not communicate with broadcast receiving device 200.

When the mutual authentication succeeds (step S34), authentication information generation unit 143 of relay processing unit 140 generates the authentication information (step S35). The generated authentication information is contained in connection management information 60 in storage unit 110. Next, authentication information imparter 145 performs control so that information terminal 100 may transmit the getURL message to which the authentication information is appended to broadcast receiving device 200 through communicator 120 (step S36).

In response to the getURL message, broadcast receiving device 200 makes the above-described response in step S17, and information terminal 100 receives the response, and further relay processing unit 140 acquires the response (step S37). The response to the getURL message is either one of the application specification that represents the external application, and the web site specification that represents the web content.

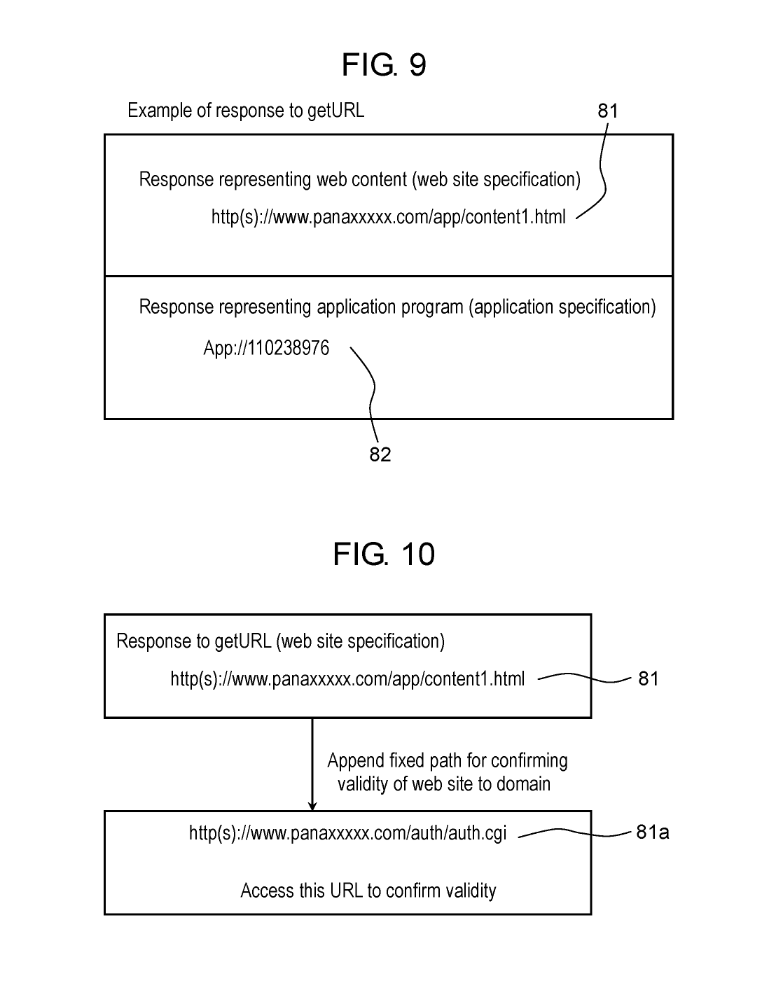

FIG. 9 is a diagram illustrating contents of the response from broadcast receiving device 200. As illustrates in FIG. 9, web site specification 81 represents a URL (Uniform Resource Locator) that refers to an address on the network, that information terminal 100 should access for acquiring the web content (that is, the address of communication device 320), for example. Application specification 82 represents a URL generated by appending a predetermined descriptor (for example, “App://”) to identification information on the external application in information terminal 100 (for example, identification information determined before the external application is downloaded).

Next, relay processing unit 140 discriminates whether the response is the application specification or the web site specification, from the URL indicated by the response to the getURL message (refer to FIG. 9) (step S38). When the response is the application specification, relay processing unit 140 starts the external application specified by the identification information represented by the application specification (step S39). When the external application is started, connection management unit 142 of relay processing unit 140 records the process ID of the external application as application process ID 66 of connection management information 60.

Subsequent to step S39, application validity verification unit 144 of relay processing unit 140 verifies validity of the external application. When the verification results in validity (step S40), relay processing unit 140 updates usage information 70 in storage unit 110 (step S41).

Updating of usage information 70 specifically means incrementing number of times of use 74 corresponding to manufacturer ID 71, etc. of broadcast receiving device 200 that succeeds in the mutual authentication in step S33. Validity of the external application is verified in step S40, for example, by the authentication made through inter-process communication between relay program 140a that constitutes relay processing unit 140 and the external application. This authentication is made at least by the external application passing information for proving the validity to relay program 140a by a previously determined procedure, such as an authentication procedure based on PKI. Subsequent to step S41, authentication information imparter 145 of relay processing unit 140 conveys the authentication information generated by authentication information generation unit 143 in step S35 to the external application whose validity has been confirmed (step S42).

Meanwhile, when the verification of the external application in step S40 does not result in validity, the external application is invalid, and thus relay processing unit 140 performs invalid application handling processing for inhibiting communication from the external application to broadcast receiving device 200 (step S43). Specifically, the invalid application handling processing is performed by controller 130 including relay processing unit 140 stopping, for example, a process of the external application indicated by application process ID 66 of connection management information 60. Moreover, as the invalid application handling processing, relay processing unit 140 transmits, to broadcast receiving device 200 via communicator 120, a message to instruct to close the predetermined communication port opened by the web socket service for communication with information terminal 100.

When it is determined in step S38 that the URL is the web site specification, relay processing unit 140 confirms whether a domain of the URL indicated by the web site specification is described in a previously determined white list. The white list is a list that lists and describes domain names or part of the domain names about one or more web sites that provide web content for broadcast and communication cooperation, the web sites being previously confirmed to be safe. If the confirmation results in that the domain of the URL indicated by the web site specification is described in the white list (step S44), application validity verification unit 144 of relay processing unit 140 verifies validity of the web site related to the web site specification. When the verification results in validity (step S45), relay processing unit 140 updates usage information 70 in storage unit 110 (step S46).

The operation of updating of usage information 70 is similar to the operation in step S41. Validity of the web site is verified in step S45 by application validity verification unit 144 attempting access to the URL created by appending a predefined fixed path for validity confirmation to the domain of the URL indicated by the web site specification. When a response that satisfies a previously determined condition is returned to the access, the web site is valid. The safety-confirmed web site (for example, communication device 320) described in the white list is configured to return a response that satisfies the previously determined condition to access that specifies the previously determined fixed path.

FIG. 10 is a conceptual diagram about a method for confirming validity of the web site. As illustrated in FIG. 10, application validity verification unit 144 appends a fixed path to web site specification 81 to generate the URL to be used for confirming validity of the web site. Assuming to access the web site and acquire data of the web page described in HTML5 etc. and a script of the browser application, etc., the verification of validity of the web site also has a meaning as verification of validity of the browser application. In verification of validity of the web site, if a response is not returned that satisfies the previously determined condition, to the access to the web site with the fixed path appended for confirming validity, the accessed web site is not valid.

Such a situation that the accessed web site is not valid occurs, for example, when a DNS (Domain Name System) server to be used by information terminal 100 is invalid. Subsequent to step S46, authentication information imparter 145 of relay processing unit 140 starts browser 160 by appending the authentication information generated by authentication information generation unit 143 in step S35 to the URL indicated by the web site specification, and passing the URL (step S47).

Browser 160 is a program previously determined in information terminal 100, and for example, may be downloaded from outside. Started browser 160 displays the web content based on the data, etc. acquired by accessing the passed URL, and causes browser application 161 to function. Browser application 161 may refer to the authentication information passed from authentication information imparter 145 to browser 160. If the verification of the web site in step S45 does not result in validity, relay processing unit 140 does not start browser 160.

As described above, in information terminal 100, under certain conditions, the external application or browser application is executed according to the URL acquired from broadcast receiving device 200 in response to the getURL message. Since the external application or browser application whose validity has been verified may refer to the authentication information, information terminal 100 may append the authentication information to the data to be transmitted to broadcast receiving device 200, and may control communication with broadcast receiving device 200 appropriately.

Relay processing unit 140 of information terminal 100 transmits usage information 70 to a predetermined server (for example, communication device 320) for totaling and processing, every time a previously defined predetermined condition independent of the above-described operation is satisfied, (for example, every time a predetermined period of time elapses).

### [1-2-3. Example of Execution of the External Application]

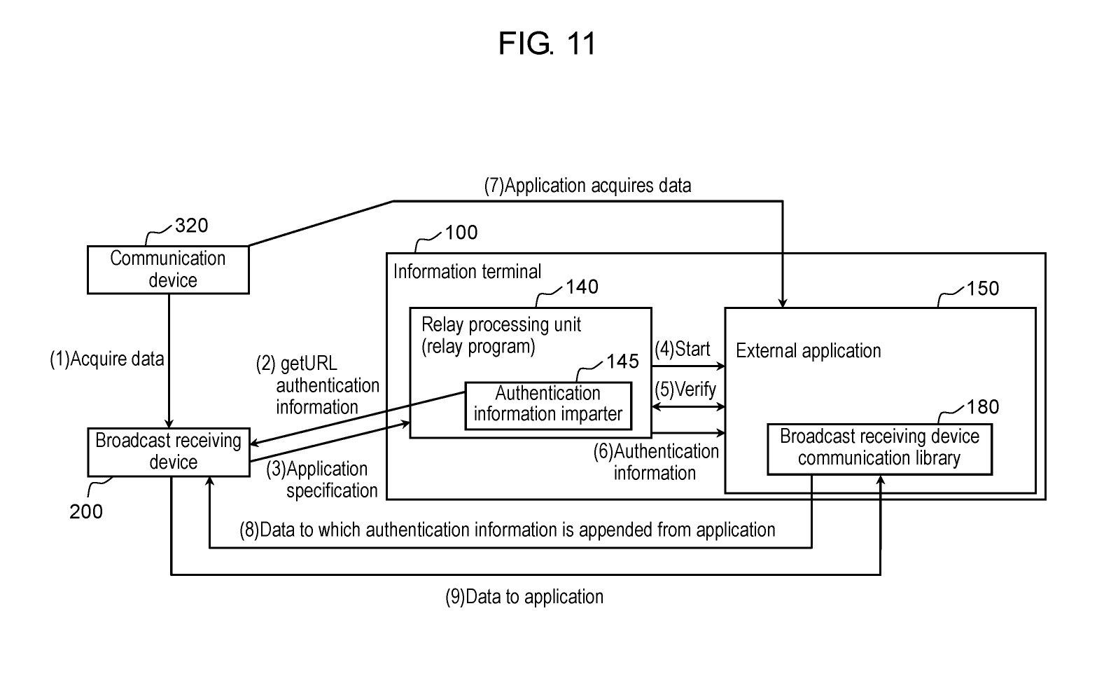

FIG. 11 is an operation sequence diagram of a major operation of information terminal 100 described above, organized by way of example where the external application is executed. For example, when a broadcast program that supports broadcast and communication cooperation and that is received by broadcast receiving device 200 has connection with the external application, the operation illustrated in FIG. 11 is performed in broadcast and communication cooperation system 10. The operation will be listed below in order of the operation.

1. Broadcast receiving device 200 acquires data (that is, web content information) from communication device 320.

2. In accordance with control by authentication information imparter 145 of relay processing unit 140 that functions by the relay program being started in information terminal 100, information terminal 100 transmits the getURL message to which the authentication information is appended to broadcast receiving device 200.

3. In response to the getURL message, broadcast receiving device 200 transmits the application specification that indicates the identification information on the external application to information terminal 100.

4. In response to the application specification, relay processing unit 140 starts external application 150.

5. Relay processing unit 140 authenticates external application 150.

6. Authentication information imparter 145 of relay processing unit 140 conveys the authentication information to external application 150 whose validity has been verified through the authentication.

7. External application 150 acquires data, for example, from communication device 320 as necessary.

8. External application 150 performs control to transmit the data (message) to which the conveyed authentication information is appended to broadcast receiving device 200, by using API for message transmission (for example, SendMsg) provided by broadcast receiving device communication library 180 as necessary. The transmission control of the message by external application 150 is performed independently, without through relay processing unit 140. An invalid external application, which does not have the authentication information, fails to append the authentication information to data and to transmit the data to broadcast receiving device 200.

9. Broadcast receiving device 200 verifies whether the already acquired authentication information appended to the getURL message coincides with the authentication information appended to the message transmitted from external application 150. If two pieces of the authentication information coincide with each other, broadcast receiving device 200 executes processing corresponding to the message from external application 150, and transmits the data to external application 150 as necessary.

Thus, broadcast receiving device 200 may be protected from the invalid external application, and may exchange data with valid external application 150.

### [1-2-4. Example of Execution of Browser Application]

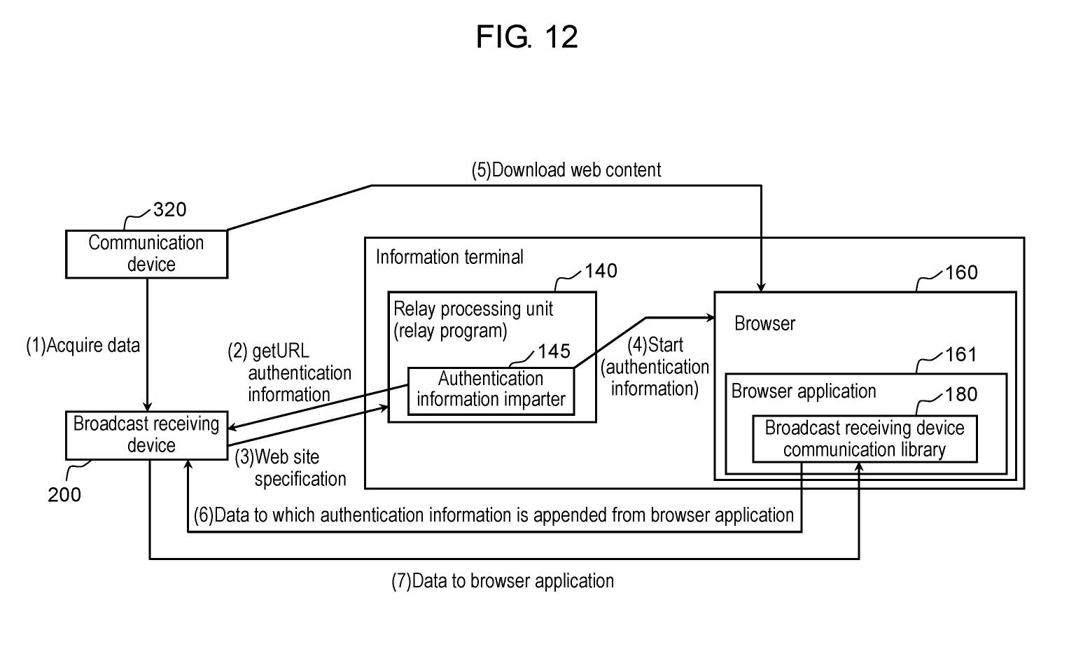

FIG. 12 is an operation sequence diagram of a major operation of information terminal 100 described above, organized by way of example where the browser application is executed. For example, when a broadcast program that supports broadcast and communication cooperation and that is received by broadcast receiving device 200 has connection with the web content including the browser application for information terminals, the operation illustrated in FIG. 12 is performed in broadcast and communication cooperation system 10. The operation will be listed below in order of the operation.

1. Broadcast receiving device 200 acquires data (that is, web content information) from communication device 320.

2. In accordance with control by authentication information imparter 145 of relay processing unit 140 that functions by the relay program being started in information terminal 100, information terminal 100 transmits the getURL message to which the authentication information is appended to broadcast receiving device 200.

3. In response to the getURL message, broadcast receiving device 200 transmits the web site specification that indicates the URL of the web content to information terminal 100. It is assumed here that this URL is a URL that refers to the web content provided by communication device 320.

4. Relay processing unit 140 confirms that the web site corresponding to the web site specification is described in the white list, verifies validity of the web site, and passes the URL and the authentication information to start browser 160 when the web site is valid.

5. Browser 160 downloads the web content including browser application 161 from communication device 320, and displays the web content.

6. Browser application 161 performs control to transmit, to broadcast receiving device 200, the data (message) to which the authentication information conveyed to browser 160 is appended, by using API for message transmission (for example, SendMsg) provided by broadcast receiving device communication library 180 as necessary.

7. Broadcast receiving device 200 verifies whether the already acquired authentication information appended to the getURL message coincides with the authentication information appended to the message transmitted from browser application 161. If two pieces of the authentication information coincide with each other, broadcast receiving device 200 executes processing corresponding to the message from browser application 161, and transmits the data to browser application 161 as necessary.

Thus, broadcast receiving device 200 may be protected from the invalid external application, and may exchange data with valid browser application 161.

### [1-2-5. Communication Sequence]

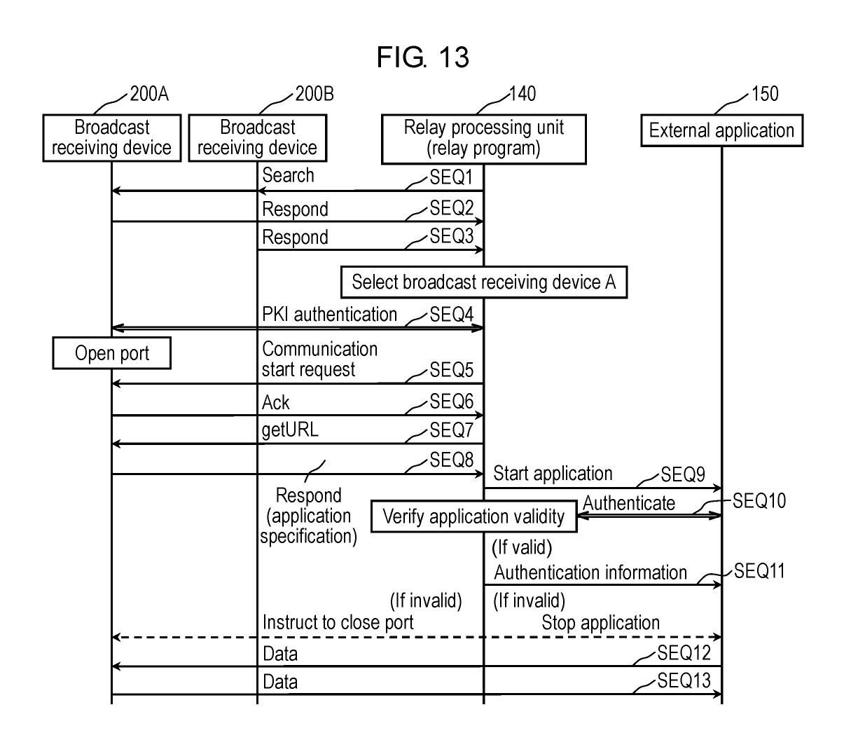

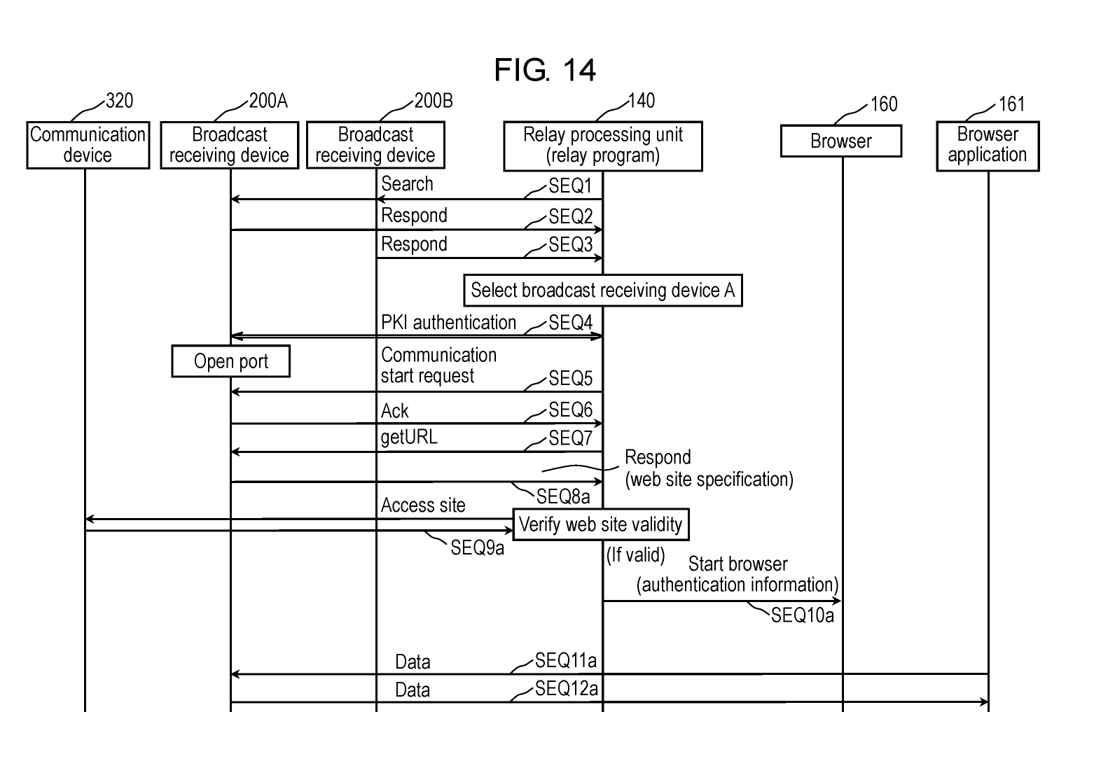

A communication sequence between broadcast receiving device 200 and information terminal 100 that perform the above-described operations (refer to FIG. 7 and FIG. 8) will be described below with reference to FIG. 13 and FIG. 14.

FIG. 13 is a diagram illustrating the communication sequence of broadcast receiving device 200 and information terminal 100. FIG. 13 also includes the communication sequence of inter-process communication between the relay program related to relay processing unit 140 that functions as a part of controller 130 in information terminal 100, and external application 150. It is assumed that there are two broadcast receiving devices 200 capable of communicating with information terminal 100 via LAN (broadcast receiving device 200A and broadcast receiving device 200B), and that the user is viewing a broadcast program received by broadcast receiving device 200A, the broadcast program supporting broadcast and communication cooperation. It is assumed that external application 150 is an external application related to the broadcast program the user is viewing, and that external application 150 is provided as downloadable from communication device 320, for example, and has already been stored in information terminal 100.

When the relay program is started in information terminal 100, as illustrated in FIG. 13, relay processing unit 140 of information terminal 100 first searches for broadcast receiving device 200 (sequence SEQ1). To this search, broadcast receiving device 200A responds (sequence SEQ2), and broadcast receiving device 200B also responds (sequence SEQ3). The following description assumes that the user manipulates information terminal 100 to select broadcast receiving device 200A.

The mutual authentication (PKI authentication) is performed between information terminal 100 and broadcast receiving device 200A under control of relay processing unit 140 (sequence SEQ4). After the mutual authentication succeeds, broadcast receiving device 200A opens a communication port for communication with information terminal 100, and information terminal 100 transmits a communication start request message to broadcast receiving device 200A under control of relay processing unit 140 (sequence SEQ5). In response to the communication start request message, broadcast receiving device 200A returns a normal response (Ack) (sequence SEQ6). Subsequently, information terminal 100 transmits, to broadcast receiving device 200A, the getURL message to which the authentication information is appended (sequence SEQ7), and broadcast receiving device 200A returns a response including the application specification (sequence SEQ8).

In information terminal 100, in response to the application specification, relay processing unit 140 starts external application 150 (sequence SEQ9), and authenticates external application 150 (step S40 of FIG. 8, sequence SEQ10). If the authentication results in that external application 150 is valid, relay processing unit 140 conveys the authentication information to external application 150 (sequence SEQ11). If external application 150 is not valid (invalid), relay processing unit 140 stops execution of external application 150, and instructs broadcast receiving device 200A to close the communication port. On receipt of the conveyed authentication information in sequence SEQ11, external application 150 performs control to append the authentication information to data (message) as necessary and to transmit the data to broadcast receiving device 200 (sequence SEQ12). Broadcast receiving device 200A determines the validity of a source of the data by verifying the authentication information appended to the data received in sequence SEQ12 by using the authentication information acquired in sequence SEQ7. When determining that the source of the data is valid, broadcast receiving device 200A transmits the data to information terminal 100 so that external application 150 may use the data as necessary (sequence SEQ13). After this, when transmitting data to broadcast receiving device 200A, external application 150 appends the authentication information to the data.

FIG. 14 is a diagram illustrating the communication sequence of broadcast receiving device 200 and information terminal 100. In an example of FIG. 14, which is similar to the example of FIG. 13 in general, browser 160 and browser application 161 are executed instead of external application 150 in information terminal 100. In FIG. 14, identical reference numerals are used to denote a sequence identical to the sequence in FIG. 13, and description thereof is omitted as appropriate.

When the relay program is started in information terminal 100, as illustrated in FIG. 14, information terminal 100 performs the mutual authentication with broadcast receiving device 200A, and passes the getURL message to which the authentication information is appended to broadcast receiving device 200A (sequence SEQ1 to SEQ7). Information terminal 100 then receives a response (response to the getURL message) including the web site specification from broadcast receiving device 200A (sequence SEQ8a).

In information terminal 100, in response to the web site specification, relay processing unit 140 verifies the validity of the web site (steps S44, S45 of FIG. 8, sequence SEQ9a). Only when the web site is valid, relay processing unit 140 passes the URL and the authentication information related to the web site specification to browser 160, and starts browser 160 (sequence SEQ10a).

Accordingly, browser 160 accesses the URL, displays the web content, and executes browser application 161. Browser application 161 performs control to append the authentication information passed to browser 160 to data (message) as necessary, and to transmit the data to broadcast receiving device 200 (sequence SEQ11a). Broadcast receiving device 200A determines the validity of a source of the data by verifying the authentication information appended to the data received in sequence SEQ11a by using the authentication information acquired in sequence SEQ7. When determining that the source of the data is valid, broadcast receiving device 200A transmits the data to information terminal 100 so that browser application 161 may use the data as necessary (sequence SEQ12a). After this, when transmitting data to broadcast receiving device 200A, browser application 161 appends the authentication information to the data.

### [1-3. Effect, Etc.]

As described above, broadcast and communication cooperation system 10 includes broadcast receiving device 200 that receives TV broadcast, and information terminal 100. Information terminal 100 includes communicator 120, storage unit 110 for storing the application program that prescribes communication processing with broadcast receiving device 200 (external application 150 or browser application 161) and other data, and controller 130. Controller 130 performs the mutual authentication with broadcast receiving device 200 to transmit the authentication information to broadcast receiving device 200. Furthermore, controller 130 verifies the validity of the application program stored in storage unit 110. Controller 130 performs control, when the verified application program is valid, to transmit the authentication information in communication with broadcast receiving device 200 according to the application program.

This allows broadcast receiving device 200 to confirm that a partner of the communication is valid by using the authentication information. Therefore, this inhibits information terminal 100 from executing an invalid application program that causes a problem such as invalid acquisition of data in broadcast receiving device 200. External application 150 may be configured to be authenticated to be valid by information terminal 100. This eliminates a need for external application 150 to have, for example, a configuration that specializes in a specific type of broadcast receiving device 200 (such as information for being authenticated by a specific type of broadcast receiving device 200). Thus, external application 150 may support various types of broadcast receiving devices 200. Similarly, browser application 161 only needs to be disposed in a valid web site, and does not need to have a configuration that specializes in a specific type of broadcast receiving device 200, for example. Thus, browser application 161 may support various types of broadcast receiving devices 200.

### Other Exemplary Embodiments

As described above, the first exemplary embodiment has been described by way of example of a technique to be disclosed in the present application. The technique in the present disclosure, however, is not limited to the example, and may be applied to exemplary embodiments to which change, replacement, addition, and omission are appropriately made.

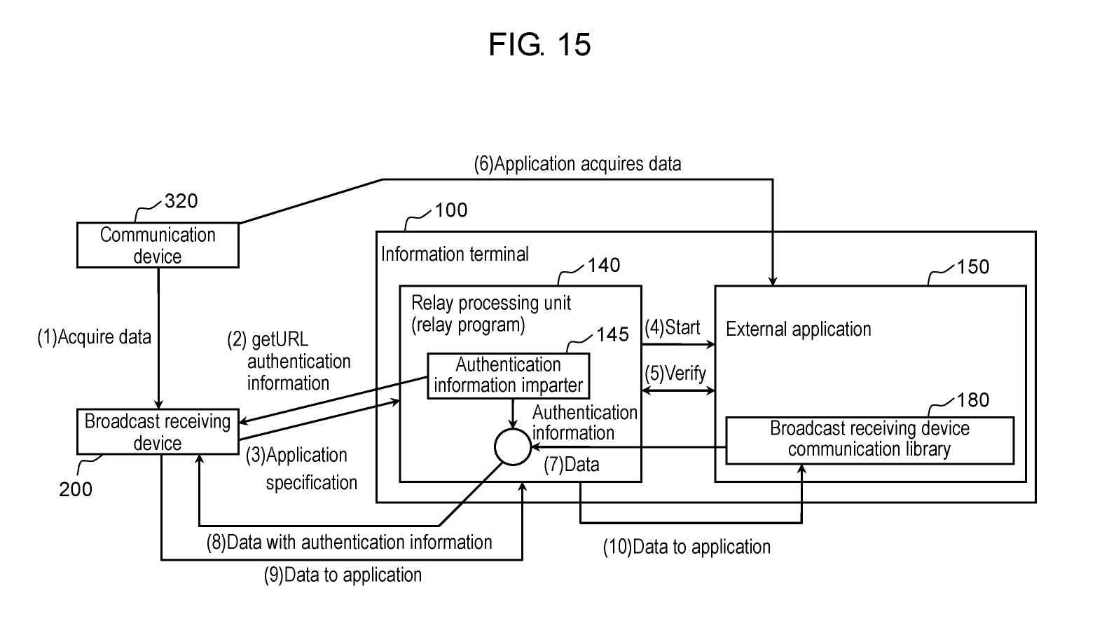

The first exemplary embodiment has described that, in information terminal 100, relay processing unit 140 of controller 130 conveys, to external application 150, the authentication information controlled to be transmitted to broadcast receiving device 200, and external application 150 performs communication with broadcast receiving devices 200 by using the authentication information (that is, by appending the authentication information to data to be transmitted). This is only one example of a method by which controller 130 performs control so that the authentication information is transmitted in communication with broadcast receiving device 200 according to external application 150 (this control is, for example, control of each unit of information terminal 100 and execution control of a program). In another example, when external application 150 verified to be valid transmits data (message) to broadcast receiving device 200, relay processing unit 140 intervenes and appends the authentication information to, for example, a header section of the message. Transmission of this message refers, for example, to using API for message transmission provided by broadcast receiving device communication library 180 (for example, SendMsg). FIG. 15 illustrates an operation sequence related to this example. The operation illustrated in FIG. 15 will be listed below in order of the operation.

1. Broadcast receiving device 200 acquires data (that is, web content information) from communication device 320.

2. In accordance with control by authentication information imparter 145 of relay processing unit 140 that functions by the relay program being started in information terminal 100, information terminal 100 transmits the getURL message to which the authentication information is appended to broadcast receiving device 200.

3. In response to the getURL message, broadcast receiving device 200 transmits the application specification that indicates the identification information on the external application to information terminal 100.

4. In response to the application specification, relay processing unit 140 starts external application 150.

5. Relay processing unit 140 authenticates external application 150. The operation from step 1 to step 5 is similar to the operation described with reference to FIG. 11 in the first exemplary embodiment. In the operation sequence illustrated in FIG. 15, authentication information imparter 145 does not perform operation for conveying the authentication information to valid external application 150. Description of the operation is continued.

6. External application 150 acquires data, for example, from communication device 320 as necessary.

7. External application 150 attempts to transmit the data (message) to broadcast receiving device 200, by using API for message transmission (for example, SendMsg) provided by broadcast receiving device communication library 180 as necessary.

8. Through intervention in the operation of API for message transmission from external application 150, authentication information imparter 145 of relay processing unit 140 performs control to append the authentication information to the message and to transmit the message to broadcast receiving device 200.

9. Broadcast receiving device 200 verifies whether the already acquired authentication information appended to the getURL message coincides with the authentication information appended to the message transmitted in accordance with external application 150. If two pieces of the authentication information coincide with each other, broadcast receiving device 200 executes processing corresponding to the message from external application 150, and transmits the data to external application 150 as necessary. Thus, broadcast receiving device 200 may exchange data with valid external application 150.

The first exemplary embodiment has described an example in which information terminal 100 searches for broadcast receiving device 200 capable of communication by an M-search message of UPnP (Universal Plug and Play). However, the method for search is not limited to the method using UPnP. For example, SIP (Session Initiation Protocol) may be used. That is, a SIP server, which receives and previously registers the manufacturer ID, the model ID, the communication method, the local IP address, and the port number from broadcast receiving device 200, may make a search and response by returning information for connection in response to a request from information terminal 100.

In the first exemplary embodiment, under control of authentication information imparter 145 in controller 130 of information terminal 100, authentication information having identical contents is conveyed to broadcast receiving device 200, and to external application 150 or browser application 161 (steps S36, S42, S47), and external application 150 or browser application 161 appends the authentication information to the message when transmitting the message to broadcast receiving device 200. Instead of appending the authentication information, external application 150 or browser application 161 may append information obtained by applying certain transformation to the authentication information. In this case, broadcast receiving device 200 also confirms the validity of the source of the message based on information obtained by applying the identical transformation to the already acquired authentication information.

In the first exemplary embodiment, under control of authentication information imparter 145 as described above, the authentication information having identical contents is conveyed to broadcast receiving device 200, and to external application 150 or browser application 161 (steps S36, S42, S47). However, authentication information imparter 145 may transmit the authentication information (first authentication information) to broadcast receiving device 200 in step S36, and may convey the authentication information verifiable by using the first authentication information (second authentication information different from the first authentication information) to external application 150 or browser application 161 in steps S42 and S47. In this case, for example, a complement of data that constitutes the first authentication information may be the second authentication information. Broadcast receiving device 200 may confirm the validity of the source of the message, for example, by calculating the complement of the second authentication information appended to the received message and comparing the complement of the second authentication information with the already retained first authentication information. For example, the first authentication information and the second authentication information may be prescribed by a public-key cryptosystem.

Operating order of broadcast receiving device 200 and information terminal 100 in broadcast and communication cooperation system 10 described in the first exemplary embodiment (for example, the procedure illustrated in FIG. 7 and FIG. 8) is not necessarily limited to operating order as described in the first exemplary embodiment. Regarding the operating order, executing order may be exchanged, and addition of another procedure, omission or change of some procedures may be carried out.

Functional components (functional blocks) of respective devices in broadcast and communication cooperation system 10 may be individually integrated into one chip using semiconductor devices such as an IC (Integrated Circuit) and an LSI (Large Scale Integration), or may be integrated into one chip so as to contain a part or all of the functional components. Also, circuit integration is not limited to the LSI, and may be implemented using a dedicated circuit or a general-purpose processor. An FPGA (Field Programmable Gate Array) that is programmable after manufacture of an LSI or a reconfigurable processor in which connections and settings of circuit cells within the LSI are reconfigurable may be used. Furthermore, if an advance in semiconductor technologies or other related technologies yields a circuit integration technology that may substitute for the LSI, the functional blocks may be integrated using such a technology. For example, adaptation of biotechnology may be possible.

All or a part of the above-described various processing procedures (for example, the procedures illustrated in FIG. 7 and FIG. 8) may be implemented by hardware of each device, or may be implemented using software. Processing by software is implemented by a processor included in each device executing a control program stored in a memory. Also, the control program may be recorded in a recording medium to be distributed and circulated. For example, installing the distributed program in the device and causing the processor of the device to execute the program makes it possible to cause the device to perform various kinds of processing (such as processing illustrated in FIG. 7 and FIG. 8).

The present disclosure may be applied to providing broadcast programs that support broadcast and communication cooperation.

What is claimed is:

1. An information terminal capable of communicating with a broadcast receiving device that receives television broadcast, the information terminal comprising:
a communicator;
a storage unit for storing an application program that prescribes communication processing with the broadcast receiving device; and
a controller configured to perform mutual authentication with the broadcast receiving device to transmit first authentication information to the broadcast receiving device, to further verify validity of the application program stored in the storage unit, and to perform control, when the verified application program is valid, to transmit, to the broadcast receiving device, second authentication information verifiable by using the first authentication information in communication with the broadcast receiving device according to the application program.

2. The information terminal according to claim 1, wherein the second authentication information is identical to the first authentication information.

3. The information terminal according to claim 2, wherein the controller generates the first authentication information having a value independent of a value of the already generated first authentication information every time the mutual authentication is performed with the broadcast receiving device.

4. The information terminal according to claim 1, wherein, when the verified application program is valid, the controller imparts the second authentication information to the application program so that the second authentication information is available for the communication processing according to the application program.

5. The information terminal according to claim 1, wherein, when the verified application program is valid, the controller performs control to transmit data to which the second authentication information is appended to the broadcast receiving device, every time transmission of the data to the broadcast receiving device is specified in the communication processing according to the application program.

6. The information terminal according to claim 1, wherein the controller receives specified information that indicates the application program from the mutually authenticated broadcast receiving device, and performs the verification of validity of the application program indicated by the specified information.

7. The information terminal according to claim 1, wherein the controller receives specified information that indicates a web site from the mutually authenticated broadcast receiving device, and performs the verification of validity of the application program by confirming that the web site indicated by the specified information is valid.

8. The information terminal according to claim 1, wherein the controller performs the mutual authentication with the broadcast receiving device that has become capable of communication through the communicator by selectively using a plurality of communication methods.

9. The information terminal according to claim 8, wherein, when the verified application program is valid, the controller records a frequency of use of the broadcast receiving device for each manufacturer in association with identification information on the manufacturer on the broadcast receiving device used when communication with the broadcast receiving device becomes possible, and performs control to transmit usage information that indicates the recorded frequency of use for each manufacturer to a predetermined external device.

10. An information processing method used by an information terminal capable of communicating with a broadcast receiving device that receives television broadcast, the information processing method comprising:
a transmission step of performing mutual authentication with the broadcast receiving device to transmit first authentication information to the broadcast receiving device;
a verification step of verifying validity of an application program stored in the information terminal; and
a control step of performing control, when the application program verified in the verification step is valid, to transmit second authentication information verifiable by using the first authentication information to the broadcast receiving device in communication with the broadcast receiving device to which the first authentication information is transmitted in the transmission step, according to the application program.

11. A control program for performing predetermined information processing through execution by a processor of an information terminal capable of communicating with a broadcast receiving device that receives television broadcast, wherein
the predetermined information processing comprises:
a transmission step of performing mutual authentication with the broadcast receiving device to transmit first authentication information to the broadcast receiving device;
a verification step of verifying validity of an application program stored in the information terminal; and
a control step of performing control, when the application program verified in the verification step is valid, to transmit second authentication information verifiable by using the first authentication information to the broadcast receiving device in communication with the broadcast receiving device to which the first authentication information is transmitted in the transmission step, according to the application program.
